(19) United States
(12) Patent Application Publication
(10) Pub. No.: US 2026/0264872 A1
(43) Pub. Date: Sep. 10, 2026

(54) DEVICE FOR THE IN-FLIGHT REFUELING OF AN AIRCRAFT

(71) Applicant: SAFRAN AEROSYSTEMS, Plaisir (FR)

(72) Inventor: Remi BATTARRA, Moissy-Cramayel (FR)

(21) Appl. No.: 19/166,417

(22) PCT Filed: Mar. 21, 2024
(86) PCT No.: PCT/FR2024/050353

§ 371 Date: Sep. 17, 2025

(30) Foreign Application Priority Data
Mar. 24, 2023 (FR) 2302534

(51) Int. Cl. B64D 39/04

(52) U.S. Cl. CPC B64D 39/04

(57) ABSTRACT

The invention relates to an in-flight refueling device, in particular for a refueling aircraft, comprising a pipe intended for transferring a fluid, comprising—a first end (102a) able to be connected to a fluid source, and —a second end equipped with an in-flight refueling connection, characterized in that it further comprises a light system arranged along at least part of the pipe and comprising at least one series of radiation sources distributed along that part of the pipe.

### TECHNICAL FIELD OF THE INVENTION

The present invention relates to the general field of the aeronautic. More specifically, it concerns an in-flight refueling device for an aircraft, and an aircraft comprising such an in-flight refueling device.

### TECHNICAL BACKGROUND

The technical background comprises the documents US-A1-2005/017130, U.S. Pat. No. A-5,539,624, DE-A1-10 2016 118302, CN-U-206 719 564, US-A1-2005/145751 and US-A2-2019/154173.

During a flight, an aircraft is known to be refueled by transferring at least one fluid, such as fuel, to it.

This is the case, for example, when an aircraft may not or must not land in an area over which it is flying. The aircraft must then be refueled in flight. This is particularly the case when the volume of fuel on board reaches a lower threshold value.

During such refueling, as shown schematically in FIG. 1, a first aircraft 14, also referred to as a tanker 14 or refueling aircraft 14, is equipped with an in-flight refueling device to which a second aircraft 22, also referred to as a receiver 22 or aircraft 22 to refuel, is connected.

The in-flight refueling device comprises a pipe 10 configured to transfer fluid, unwound from the first aircraft to the second aircraft, which is located downstream of the first aircraft, in the direction of flight, and which is to be refueled.

The pipe 10 may be unwound or deployed from a downstream end of a fuselage 12 of the refueling aircraft 14, as shown in FIG. 1, or from a wing of the refueling aircraft 14.

Alternatively, the pipe 10 may be deployed from a carrier, also referred to as a nacelle, installed on the ventral point of an aircraft, in particular a fighter aircraft, or from a carrier installed under the wing of an aircraft, in particular a refueling aircraft or a fighter aircraft.

The pipe 10, suitable for transferring fluid, comprises a first end 10a, connected to a fluid source 16, and comprising for example a reservoir and a pump, and a second end 10b, opposite the first end 10a, and comprising a first connector 18.

The first connector 18 is configured to provide a fluidic connection with a second connector 20, which may cooperate in a complementary manner. The second connector 20 is carried, in particular by a boom, from the aircraft to be refueled 22. This type of connection is well known to the person skilled in the art.

The first connector 18 comprises, for example, a pressure-limiting member 24 and a frustoconical basket 26. To this end, the connector 18 may comprise a valve allowing the pressure at the outlet of the first connector 18 to be set to the limit prevailing in the medium.

The frustoconical basket 26 helps to center and guide the second connector 20 inside the first connector 18. To this end, the second connector 20 has a pointed shape which cooperates with the pressure-limiting member 24 of the first connector 18.

The frustoconical basket 26 is also shaped to facilitate a centering of the first connector 18 in the air flow.

The pipe 10 is unwound by means of a pipe 10 deployment system located inside the refueling aircraft 14 or inside the carrier of the refueling aircraft 14.

When the refueling aircraft 14 takes off, the pipe 10 is wound. During a refueling operation, the unwinding of the pipe 10 is controlled so as to unwind a sufficient length of the pipe 10, for example over several tens of metres, in particular a length of between 15 metres and 30 metres, so that the first connector 18 approaches the second aircraft 22 and may be connected to the second connector 20 of the second aircraft 22.

The pipe 10 is relatively flexible and is likely to move and shift as it is unwound and subjected to disturbances downstream of the first aircraft 14 or to turbulence.

If the movements of the pipe 10 are too great and uncontrolled, they may come into contact with the refueling aircraft 14 and/or the second aircraft 22.

When the pipe 10 is connected to the second connector 20 on the aircraft 22 to be refueled and when the aircraft 22 to be refueled is refueled, waves are generated along the pipe 10 and result in undulations in the pipe.

The characteristics of such waves are that they are liable to damage the second connector 20, in particular the boom, of the aircraft to be refueled 22.

Such waves may cause the second connector 20 to break, necessitating an emergency landing of the aircraft to be refueled 22, following such damage.

Depending on the flight conditions, the movements and the undulations of the pipe 10 may not be perceptible to the pilot of the refueling aircraft 22, or may be difficult to perceive, particularly during a night flight.

A pipe 10, configured to transfer a fluid during refueling, may comprise white annular strips extending around the pipe 10 and visible to the pilot of the aircraft 22 to be refueled. Such annular strips allow the pilot to see the length of the pipe 10 deployed, but do not allow him to visualise a waveform or appreciate its propagation speed.

When the pilot of the aircraft to be refueled 22 detects a movement or an undulation of the pipe 10, he may uncouple the second connector 20 from the pipe 10 and extract himself from a risky situation.

However, when flying at night or in reduced visibility, for example in the presence of fog and/or clouds, the pilot of the aircraft to be refueled 22 is unable to see the type of movement or undulation using the current technique.

In addition, the frustoconical basket 26 carried by the pipe 10 may be equipped with a light system configured to make it easier for the pilot of the aircraft 22 to be refueled to locate it.

However, when the second connector 20 of the aircraft to be refueled 22 is connected to the pressure limiting member 24, the frustoconical basket 26 no longer follows the movements and the undulations of the pipe 10.

The aircraft to be refueled 22 may comprise a headlamp. However, a headlamp of this type is generally not powerful enough to illuminate several tens of metres and may lose effectiveness depending on the weather conditions.

The purpose of the present invention is to provide a solution to at least some of the problems of the prior art which is simple, effective and economical.

### SUMMARY OF THE INVENTION

The invention relates to an in-flight refueling device, in particular for a refueling aircraft, comprising a pipe configured to transfer of a fluid, this pipe comprising:
a first end suitable for connection to a fluid source, and
a second end equipped with an in-flight refueling connector,

The in-flight refueling device also comprises a light system arranged along at least one part of the pipe, capable of being connected to an energy source, in particular located on the side of the first end of the pipe, and comprising at least one series of radiation sources distributed along the part of the pipe, in particular the radiation sources are evenly distributed along the part of the pipe.

The invention proposes equipping the pipe with a light system, i.e. a system capable of emitting a radiation, in particular the light. The light system is distributed along part or all of the length of the pipe. When the pipe undergoes movements or undulations, the light system follows such movements and undulations. It is then possible to see such movements with the naked eye, even in semi-darkness or poor visibility, particularly at night.

The light system may be connected to an energy source that supplies it with the energy required to emit the radiation. The energy source is chosen according to the nature of the light system.

The in-flight refueling device according to the invention may also have one or more of the following characteristics, taken alone or in combination with each other:
the radiation sources are spaced apart by a distance of between 20 cm and 100 cm, preferably between 40 cm and 60 cm, and for example 50 cm;
the radiation source is chosen from a light-emitting diode, a light-emitting fibre, an optical fibre and/or a piezoelectric strip;
the light system comprises at least two series of radiation sources, respectively distributed over at least two lines extending along the pipe and angularly spaced from each other around the pipe;
the light system comprises two lines of radiation sources located at 180° apart to each other around the pipe;
the light system comprises three lines of radiation sources spaced apart from one another by an angle of between 60° and 120°;
the light system comprises four lines of radiation sources spaced apart at an angle of between 60° and 90°;
the radiation sources are distributed on a straight line along the pipe;
the radiation sources are distributed on a line wound helically around the pipe;

the light system is attached to an external periphery of the pipe;
the light system is integrated into the pipe;
the pipe is multilayer;
the pipe comprises at least one metal layer, one elastomer layer and one textile layer;
the light system is integrated, for example by weaving, into the textile layer; this allows to improve the durability and visibility of the light system;
the energy source is a light and/or electrical energy source; and/or
the light system is configured to emit a radiation in the visible, infrared and/or ultraviolet range.

The invention also relates to an assembly comprising an in-flight refueling device as described above, and a source of fluid, such as fuel, able to be connected to the first end of the pipe.

The present invention also relates to an aircraft comprising an in-flight refueling device and/or an assembly as described above.

### BRIEF DESCRIPTION OF THE FIGURES

Further characteristics and advantages of the invention will become apparent from the following detailed description, for the understanding of which reference is made to the attached drawings wherein:

FIG. 1 is a schematic view of a refueling aircraft equipped with an in-flight refueling device for an aircraft to be refueled;

FIG. 2 is a schematic view of an embodiment of an in-flight refueling device according to the invention;

FIG. 3 is a schematic view of another embodiment of an in-flight refueling device according to the invention;

FIG. 4 is another schematic view of the in-flight refueling device in FIG. 3 undergoing an undulation;

FIG. 5 is a schematic view of a variant embodiment of an in-flight refueling device according to the invention; and

FIG. 6 is a schematic view of another variant embodiment of an in-flight refueling device according to the invention.

### DETAILED DESCRIPTION OF THE INVENTION

FIG. 2 illustrates an embodiment of an in-flight refueling device 100 according to the invention.

More specifically, FIG. 2 is a perspective view of the embodiment of the in-flight refueling device 100 according to the invention.

The in-flight refueling device 100 comprises a pipe 102 configured to allow a fluid transfer.

The pipe 102 comprises a first end 102a configured to be connected to a fluid source 106, and a second end 102b equipped with an in-flight refueling connector 108.

For example, the pipe 102 has a length L of around ten metres or several tens of metres, in particular a length of between 10 m and 30 m.

The pipe 102 is preferably a multi-layer pipe comprising, for example, a metal layer, an elastomer layer and a textile layer.

The fluid source 106 may comprise at least one fluid reservoir and a pump. The fluid is, for example, fuel.

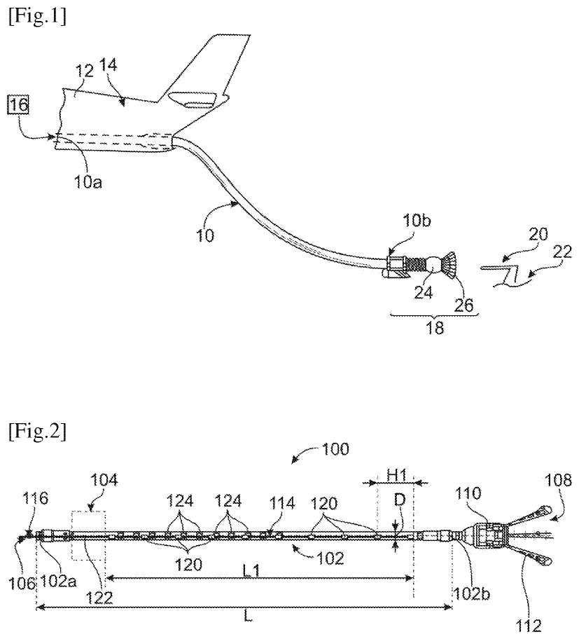

The in-flight refueling connector 108 is of the type described above in relation to FIG. 1 and comprises, for example, a pressure limiting member 110 and a frustoconical basket 112.

The pipe 102 may be associated with a deployment system 104 configured to allow the pipe 102 to be deployed, in particular by winding and unwinding the pipe 102.

The deployment system 104 for the pipe 102 is capable of winding the pipe 102 around an axis and unwinding it to a desired length to ensure in-flight refueling. The deployment system 104 is, for example, of the winch type.

The deployment system 104 may comprise a part for attachment to a structure of a refueling aircraft 118. Such an attachment part may be, for example, an attachment flange, not shown in the figures.

The in-flight refueling device 100 also comprises a radiation system 114, in particular a light system 114, arranged along at least a part of the pipe 102. The radiation system 114 may be connected to an energy source 116.

The energy source 116 may be located on the side of the first end 102a of the pipe 102, in particular located in the aircraft. Alternatively, the power source 116 may be located at the level of the in-flight refueling connector 108 or of the deployment system 104.

The light system 114 comprises at least one radiation source 120, in particular a series of radiation sources 120, in particular a series of light points 120.

The light system 114 extends, for example, over a length L1, on the pipe 102, for example several metres, in particular over more than a third, in particular over more than half, more specifically over more than three quarters of a total length L of the pipe 102.

The radiation sources 120 may be evenly distributed along the pipe 102 or a part of the pipe 102. More particularly, the radiation sources 120 may be regularly spaced from each other by a distance H, in particular between 20 cm and 100 cm, preferably between 40 cm and 60 cm, and for example 50 cm.

The radiation source 120 may be selected from a light-emitting diode (LED), a luminous fibre, an optical fibre and/or a piezoelectric strip.

The radiation source 120 is configured to emit a light in the visible, infrared and/or ultraviolet range.

If a light-emitting diode or a light fibre is used, the radiation source 120 may be connected to the energy source 116 by at least one electrical conductor 122, such as a wire. The electrical conductor 122 may extend along the pipe 102. In this configuration, the energy source 116 is an electrical energy source.

If an optical fibre is used, the optical fibre may extend along the pipe 102. The optical fibre may be connected to the power source 116. In this configuration, the energy source 116 is a light energy source.

If a piezoelectric strip is used, when the pipe 102 is deformed, the piezoelectric strip also deforms and generates a voltage used as a power source 116.

The pipe 102 may also comprise white annular strips 124, as mentioned above.

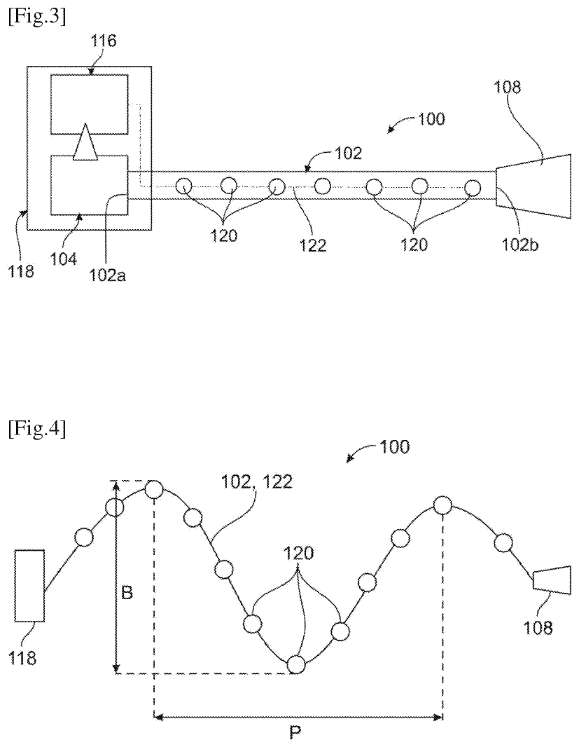

FIG. 3 is a schematic view of another embodiment of the in-flight refueling device 100 according to the invention. More particularly, FIG. 3 shows another embodiment of the in-flight refueling device 100 wherein the energy source 116 is located in the refueling aircraft 118. For example, in such a configuration, the energy source 116 may be located next to or on the deployment system 104 of the pipe 102.

The energy source 116 may be an electrical generator, of the dynamoelectric machine type, configured to generate an electrical energy when the pipe 102 is deployed, in particular when it is unwound and wound up.

For example, the pipe 102 is wound onto a drum that may rotate about the aforementioned axis, the electrical generator comprising, for example, a rotor rotated by the drum.

FIG. 4 is another schematic view of the in-flight refueling device 100 of FIG. 3 undergoing an undulation. In particular, FIG. 4 illustrates the general principle of the invention.

During an in-flight refueling, the pipe 102 was deployed over several metres. A wave is likely to be generated and propagate along the pipe. This may be, for example, as a result of the in-flight refueling connector 108 impacting on the second connector 20, in particular the boom, of the aircraft to be refueled.

The wave takes the form of an undulation in the pipe 102, which may have a period P of between 2m and 4m and a maximum amplitude B of between 50 cm and 150 cm.

The wave may cause the second connector 20, in particular the boom, to break, necessitating an emergency landing of the aircraft to be refueled following such damage.

The presence of the radiation sources 120 at regular intervals allows the pilot of the aircraft to be refueled to visualise the general shape of the pipe 102. As a result, the pilot of the aircraft to be refueled may see the formation of the undulations.

If the undulations detected are too great, the pilot of the aircraft to be refueled may then decide to disconnect the second connector 20, in particular the boom, of the aircraft to be refueled from the pipe 102.

The presence of radiation sources 120 allows the pilot of the aircraft to be refueled to appreciate the shape and speed of the wave, even during a night flight, which is particularly advantageous.

In one embodiment, the radiation sources 120 are distributed along a line, which may be a straight line parallel to a longitudinal axis A of the pipe 102.

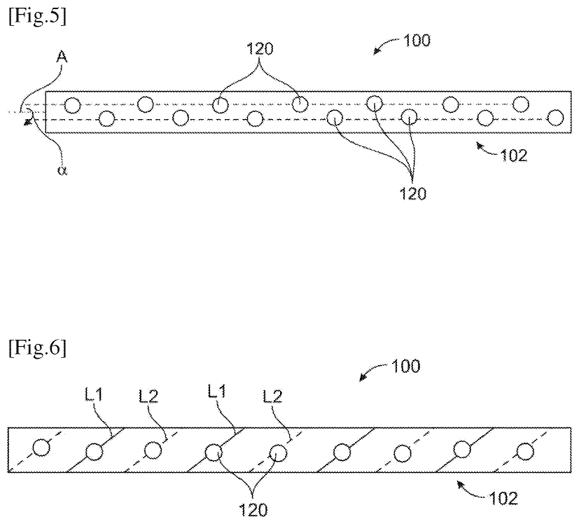

FIGS. 5 and 6 are schematic views of alternative embodiments of the in-flight refueling device 100 according to the invention.

The radiation sources 120 may be distributed in a line wound helically around the pipe 102.

The light system 114 may comprise two or more series of radiation sources 120, respectively distributed in two or more lines extending along the pipe 102.

The lines of radiation sources 120 may be angularly spaced from each other or from each other around the pipe 102.

In the event that the pipe 102 or the light system 114 comprises two lines L1, L2 of radiation sources 120, the lines L1, L2 may be located at an angle a of 180° to each other around the pipe, i.e. diametrically opposite each other with respect to the longitudinal axis A of the pipe 102.

In the event that the pipe 102 or the light system 114 comprises three lines of radiation sources 120, these lines may be spaced apart by an angle a of between 60° and 120°.

In the case where the pipe 102 or the light system 114 comprises four lines of radiation sources 120 spaced apart from each other by an angle a of between 60° and 90°.

The light system 114 may be fitted and attached, for example by gluing, to an external periphery of the pipe 102.

Alternatively, the light system 114 may be integrated into the pipe 102. In the aforementioned case where the pipe 102 is of the multilayer type, the light system 114 may be integrated into a textile layer, for example by weaving.

The in-flight refueling device 100 according to the invention may in particular be arranged:
inside the refueling aircraft 118;
at a downstream end of a fuselage of the refueling aircraft 118;
under a wing of the refueling aircraft 118; and/or
in a carrier, also referred to as a nacelle, installed
   at a belly point of the refueling aircraft 118, and/or
   under the wing of the refueling aircraft 118.

The invention improves the safety of refueling missions, particularly at night, by allowing the pilot of the aircraft to be refueled to carry out an emergency disconnection if he deems it necessary. With the current technology, the pilot of the aircraft to be refueled may not anticipate the generation of a wave and is totally dependent on the overall behaviour of the in-flight refueling device.

1. An in-flight refueling device, in particular for a refueling aircraft, comprising:
a pipe configured to transfer a fluid, this pipe comprising a first end suitable for connection to a fluid source and a second end equipped with an in-flight refueling connector, and
a light system, arranged along at least a part of the pipe, capable of being connected to an energy source, and comprising at least one series of radiation sources distributed along the part of the pipe,
wherein the pipe is of the multilayer type and comprises at least one metal layer, one elastomer layer and one textile layer, and in that the light system is integrated into the textile layer.

2. The in-flight refueling device according to claim 1, wherein the radiation sources are spaced apart by a distance of between 20 cm and 100 cm, preferably between 40 cm and 60 cm, and for example 50 cm.

3. The in-flight refueling device according to claim 1, wherein the radiation source is chosen from a light-emitting diode, a light-emitting fibre, an optical fibre and/or a piezoelectric strip.

4. The in-flight refueling device according to claim 1, wherein the light system comprises at least two series of radiation sources, respectively distributed over at least two lines extending along the pipe and angularly spaced from each other around the pipe.

5. The in-flight refueling device according to claim 4, wherein the light system comprises two lines of radiation sources located at 180° to each other around the pipe.

6. The in-flight refueling device according to claim 4, wherein the light system comprises three lines of radiation sources spaced apart from one another by an angle of between 60° and 120°.

7. The in-flight refueling device according to claim 4, wherein the light system comprises four lines of radiation sources spaced apart at an angle of between 60° and 90°.

8. The in-flight refueling device according to claim 1, wherein the radiation sources are distributed on a straight line along the pipe.

9. The in-flight refueling device according to claim 1, wherein the radiation sources are distributed on a line wound helically around the pipe.

10. The in-flight refueling device according to claim 1, wherein the light system is attached to an external periphery of the pipe.

11. The in-flight refueling device according to claim 1, wherein the light system is integrated into the pipe.

12. The in-flight refueling device according to claim 11, wherein the light system is integrated by weaving into the textile layer.

13. An assembly comprising an in-flight refueling device according to claim 1, and a source of fluid, such as fuel, able to be connected to the first end of the pipe.

14. An aircraft comprising an in-flight refueling device according to claim 1 and/or an assembly comprising a source of fluid, such as fuel, able to be connected to the first end of the pipe.
